(19) United States
(12) Patent Application Publication
(10) Pub. No.: US 2016/0238738 A1
(43) Pub. Date: Aug. 18, 2016

(54) METHOD, APPARATUS, AND COMPUTER PROGRAM PRODUCT FOR PROGRAMMATICALLY PERFORMING MEDIA DETECTION UTILIZING A DUAL SENSOR MEDIA DETECTION SYSTEM

(71) Applicant: ZIH Corp., Lincolnshire, IL (US)

(72) Inventors: Kevin M. Lemoi, Attleboro, MA (US); Kenneth V. Naegele, Licolnshire, IL (US); David F. Beck, Exeter, RI (US); Patrick J. Hegarty, Deham, MA (US)

(21) Appl. No.: 14/623,066

(22) Filed: Feb. 16, 2015

(51) Int. Cl. G01V 8/20; B41J 11/00

(52) U.S. Cl. CPC G01V 8/20; B41J 11/002

(57) ABSTRACT

Methods, apparatuses, and computer program products are described herein that are configured for determining the presence of media. More particularly, various embodiments of the present invention enable programmatic media detection utilizing a dual sensor media detection system. One example embodiment may include a media detection apparatus comprising a first sensor comprised of a first emitter and a first detector, the first sensor disposed on a first side of a media path, a second sensor comprised of a second emitter and a second detector, the second sensor disposed on a second side of the media path, wherein the second detector of the second sensor is positioned to receive electromagnetic energy transmitted by the first emitter of the first sensor when media is absent from the media path.

### FIELD

Example embodiments of the present invention generally relate to providing systems, apparatuses, methods, and user interfaces for programmatically performing media detection utilizing a dual sensor media detection system.

### BACKGROUND

Applicant has identified a number of problems, drawbacks, and design deficiencies in conventional media detection systems for printers. Such problems and deficiencies cause conventional printers to misidentify whether media is present or absent and may cause the printer itself to be larger and more expensive than would otherwise be desired. In this regard, areas for improving current media detection systems have been identified. Through applied effort, ingenuity, and innovation, solutions to improve such systems have been realized and are described in connection with embodiments of the present invention.

### BRIEF SUMMARY

In general, embodiments of the present invention provided herein include systems, methods, apparatuses, and user interfaces for programmatically performing media detection utilizing a dual sensor media detection system.

In some embodiments, a media detection apparatus may be provided, a first sensor comprised of a first emitter and a first detector, the first sensor disposed on a first side of a media path, a second sensor comprised of a second emitter and a second detector, the second sensor disposed on a second side of the media path, wherein the first detector of the first sensor is positioned to receive electromagnetic energy transmitted by the second emitter of the second sensor when media is absent from the media path, and wherein the second sensor is positioned offset from the first sensor.

In some embodiments, the media detection apparatus may further comprise a first media path guide defining a first recess, and a second media path guide defining a second recess, wherein the first sensor is positioned in the first recess such that the first detector is positioned to receive electromagnetic energy emitted from the first emitter when media is present in the media path, the first sensor configured to output a first detection signal in an instance in which electromagnetic energy is received, and wherein the second sensor is positioned in the second recess such that the second detector is positioned to receive electromagnetic energy emitted from the second emitter when media is present in the media path, the second sensor configured to output a second detection signal in an instance in which electromagnetic energy emitted is received.

In some embodiments, the media detection apparatus may further comprise control circuitry configured to activate at least one of the first emitter and the second emitter to transmit electromagnetic energy, in response to activation of the first emitter, determine a media present status by determining if the first sensor provides the first detection signal, in response to activation of the second emitter, determining a media present status by determining if the second sensor provides the second signal or if the first signal fails to provide the first signal, and, in an instance in which the media present status is determined, reporting the presence of the media. In some embodiments, the second sensor is positioned upstream of the first sensor.

In some embodiments, the media detection apparatus may further comprise a driving mechanism for moving the media along the media path, wherein the control circuitry is further configured to in an instance in which the media present status is determined, activate a primary sensor, the primary sensor being one of the first sensor, the second sensor, or the gap sensor, engage the driving mechanism to move the media such that a bar or a gap can be registered to the primary sensor, register the primary sensor to the bar or the gap.

In some embodiments, the media detection apparatus may further comprise control circuitry further configured to perform bar detection, bar detection comprising, in an instance in which presence of the media is determined due to the first detection signal, causing the second emitter to emit electromagnetic energy, the first sensor and the second sensor configured to output a third detection signal in an instance in which the electromagnetic energy emitted from the second emitter is received, and determining, based on not receiving the third detection signal, presence of the bar on the first side of the media.

In some embodiments, the media detection apparatus may further comprise control circuitry further configured to perform bar detection, bar detection comprising, in an instance in which presence of the media is determined due to the first detection signal, causing the second emitter to emit electromagnetic energy, the first sensor and the second sensor configured to output a third detection signal in an instance in which a portion of the electromagnetic energy emitted from the second emitter received at the first detector or the second detector meets a predetermined threshold, and determining, based on not receiving the third detection signal, presence of the bar on the first side of the media.

In some embodiments, the media detection apparatus may further comprise control circuitry further configured to perform gap detection, gap detection comprising, in an instance in which presence of the media is determined due to first signal, causing the second emitter to emit electromagnetic energy, the first sensor configured to output a fourth detection signal in an instance in which the electromagnetic energy emitted from the second emitter is received, and determining, based on reception of the fourth detection signal, a gap present status. In some embodiments, the electromagnetic energy is infrared light.

In some embodiments, a method for determining whether a media object is present in a media detection apparatus may be provided, the method comprising activating a first emitter, the first emitter being a part of a first sensor, the first sensor further comprised of a first detector, the first sensor positioned such that the first emitter is positioned to emit electromagnetic energy toward a media path and the first detector is positioned to receive electromagnetic energy emitted from the first emitter and reflected off a first side of a media, the first sensor configured to provide a first detection signal in an instance in which electromagnetic energy is received by the first detector, in response to activation of the first emitter, determining a media present status in an instance in which a first detection signal is received from the first sensor, activating a second emitter, the second emitter being a part of a second sensor, the second sensor further comprised of a second detector, the second sensor positioned such that the second emitter is positioned to emit electromagnetic energy toward the media path and the second detector is positioned to receive the electromagnetic energy emitted from the second emitter and reflected off a second side of the media, the first detector of the first sensor positioned to receive electromagnetic energy transmitted by the second emitter of the second sensor when media is absent from the media path, the second sensor configured to provide a second detection signal in an instance in which electromagnetic energy is received by the second detector, in response to activation of the second emitter, determining a media present status in an instance in which in which a second detection signal is received from the second sensor or in an instance in which the first detection signal is not received from the first sensor, and, in an instance in which the media present status is determined, reporting the presence of the media. In some embodiments, the second sensor is positioned upstream of the first sensor.

In some embodiments, the method may further comprise, in an instance in which the media present status is determined, activating a primary sensor, the primary sensor being one of the first sensor, second sensor, or a gap sensor, engaging a driving mechanism to move the media such that a bar or a gap can be registered to the primary sensor, the driving mechanism configured for move the media along a media path, and registering the primary sensor to the bar or the gap.

In some embodiments, the method may further comprise performing a predetermined number of activation attempts before failing the registration and displaying an error. In some embodiments, the method may further comprise, in an instance in which presence of the media is determined due to the first detection signal, causing the second emitter to emit electromagnetic energy, the first sensor and the second sensor configured to output a third detection signal in an instance in which the electromagnetic energy emitted from the second emitter is received, and determining, based on not receiving the third detection signal, a bar present status.

In some embodiments, the method may further comprise, in an instance in which presence of the media is determined due to the first detection signal, causing the second emitter to emit electromagnetic energy, the first sensor and the second sensor configured to output a third detection signal in an instance in which a portion of the electromagnetic energy emitted from the second emitter received at the first detector or the second detector meets a predetermined threshold, and determining, based on not receiving the third detection signal, bar present status.

In some embodiments, the method may further comprise, in an instance in which presence of the media is determined due to first detection signal, causing the second emitter to emit electromagnetic energy, the first sensor configured to output a fourth detection signal in an instance in which the electromagnetic energy emitted from the second emitter is received, the fourth detection signal indicative of the presence of a gap, and determining, based on reception of the fourth detection signal, a gap present status. In some embodiments, the electromagnetic energy is infrared light.

In some embodiments, a printer may be provided, the printer comprising a dual sensor media detection system and control circuitry, the dual sensor media detection system comprising a first sensor comprised of a first emitter and a first detector, the first sensor disposed on a first side of a media path, a second sensor comprised of a second emitter and a second detector, the second sensor disposed on a second side of the media path, wherein the first detector of the first sensor is positioned to receive electromagnetic energy transmitted by the second emitter of the second sensor when media is absent from the media path, and wherein the second sensor is positioned offset from the first sensor, and the control circuitry configured to activate at least one of the first emitter and the second emitter to transmit electromagnetic energy, in response to activation of the first emitter, determine a media present status by determining if the first sensor provides the first signal, in response to activation of the second emitter, determine a media present status by determining if the second sensor provides the second signal or if the first signal fails to provide the first signal, and, in an instance in which the media present status is determined, reporting the presence of the media.

In some embodiments, the dual sensor media detection system comprises a first media path guide defining a first recess, and a second media path guide defining a second recess, wherein the dual sensor media detection system is further configured such that the first sensor is positioned in the first recess such that the first detector is positioned to receive electromagnetic energy emitted from the first emitter when media is present in the media path, the first sensor configured to output a first signal in an instance in which electromagnetic energy is received, and the second sensor is positioned in the second recess such that the second detector is positioned to receive electromagnetic energy emitted from the second emitter when media is present in the media path, the second sensor configured to output a second signal in an instance in which the electromagnetic energy emitted from the second emitter is received.

In some embodiments, the dual sensor media detection system further comprising a driving mechanism for moving the media along the media path, wherein the control circuitry is further configured to, in an instance in which the present status is determined, activate a primary sensor, the primary sensor being one of the first sensor, the second sensor, or a gap sensor, engage the driving mechanism to move the media such that a bar or a gap can be registered to the primary sensor, and register the primary sensor to the bar or the gap.

In some embodiments, the dual sensor media detection system is further configured such that the control circuitry further configured to perform bar detection, bar detection comprising, in an instance in which presence of the media is determined due to the first detection signal, causing the second emitter to emit electromagnetic energy, the first sensor and the second sensor configured to output a third detection signal in an instance in which the electromagnetic energy emitted from the first emitter is received, and determining, based on not receiving the third detection signal, presence of the bar on the first side of the media.

In some embodiments, the dual sensor media detection system is further configured such that the control circuitry may be further configured to perform gap detection, gap detection comprising, in an instance in which presence of the media is determined due to first detection signal, causing the second emitter to emit electromagnetic energy, the first sensor configured to output a fourth detection signal in an instance in which the electromagnetic energy emitted from the second emitter is received, the fourth detection signal indicative of the presence of a gap, and determining, based on reception of the fourth detection signal, presence of the gap. In some embodiments, the electromagnetic energy is infrared light.

### BRIEF DESCRIPTION OF THE SEVERAL VIEWS OF THE DRAWINGS

Having thus described some embodiments in general terms, reference will now be made to the accompanying drawings, which are not necessarily drawn to scale, and wherein:

FIG. 1 illustrates a printer structured to include a dual sensor media detection system according to an exemplary embodiment;

FIG. 2 illustrates a top perspective view of the printer of FIG. 1 with a media cover in the opened media position;

FIG. 3 shows a cross-sectional representation of a printing mechanism of the printer of FIG. 1 and the media path defined through the printing mechanism;

FIG. 4 shows an expanded portion of FIG. 3 illustrating the dual sensor array, in accordance with some example embodiments of the present invention;

FIG. 5 shows a block diagram illustrating an exemplary dual sensor media detection system in accordance with some example embodiments of the present invention;

FIGS. 6A and 6B show block diagrams illustrating an exemplary dual sensor array in accordance with some example embodiments of the present invention;

FIG. 7 shows a flow chart of exemplary method, performed in accordance with some embodiments of the present invention;

FIGS. 8A-8D show exemplary block diagrams illustrating various embodiments of use cases for the dual sensor media detection system in accordance with some embodiments; and

FIGS. 9, 10, and 11 show flow charts of exemplary methods, performed in accordance with some embodiments of the present invention.

### DETAILED DESCRIPTION

Embodiments of the present inventions now will be described more fully hereinafter with reference to the accompanying drawings, in which some, but not all embodiments of the inventions are shown. Indeed, embodiments of these inventions may be embodied in many different forms and should not be construed as limited to the embodiments set forth herein; rather, these embodiments are provided so that this disclosure will satisfy applicable legal requirements. Like reference numerals refer to like elements throughout. Further, the term “exemplary” as used herein is defined to indicate an example, and should not be construed to indicate a qualitative assessment.

As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, hosts, and/or the like.

While the foregoing description refers to infrared light, one of ordinary skill would appreciate that the specification and claims may, in some embodiments, include, or more broadly be directed, to any method of transmitting or form of electromagnetic energy irrespective of wavelength. Accordingly, as used herein, “electromagnetic energy” may include, but is not limited to, infrared, visible, ultraviolet and other wavelength regions of the electromagnetic spectrum. The electromagnetic energy may be delivered in a continuous wave or in pulses, and the pulse width may be any time interval.

The sensors described herein may be, for example, any style and/or model (e.g., reflective sensors such as SFH9202 sensors from Osram®) and may be selected due to the requirements, dimensions, and/or constraints required of the printer.

### Overview

Various embodiments of the present invention are directed to improved systems, apparatuses, methods, user interfaces, and computer readable media for determining the presence of media. More particularly, various embodiments of the present invention enable programmatic media detection utilizing a dual sensor media detection system.

The term “media” as referred to herein refers to any printable receipt, label (e.g., carrier supported or linerless), wristband, packing slip, or other indicia receiving medium whether cellulose based (e.g., paper), polymer based, or some blend or combination thereof. Media as described herein may be printed by direct thermal printing, thermal transfer printer, or intermediate thermal transfer printing techniques as will be apparent to one of ordinary skill in the art.

In one particular example embodiment, a media detection apparatus may utilize a first sensor comprised of a first emitter and a first detector, the first sensor disposed on a first side of a media path and a second sensor comprised of a second emitter and a second detector, the second sensor disposed on a second side of the media path to determine the presence of media. The second detector of the second sensor may be positioned to receive infrared light transmitted by the first emitter of the first sensor when media is absent from the media path. The first detector of the first sensor may be positioned to limit reception of infrared light transmitted by the second emitter of the second sensor when the media is absent from the media path.

Advantageously, a system structured as described herein may identify whether media is present in the media path by activating the two sensors in succession. Specifically, the first detector may be positioned to receive infrared light emitted from the first emitter when media is present in the media path, such as for example, due to, in some exemplary embodiments, the infrared light reflecting off of a white (i.e., reflective rather than infrared light absorbent) surface of the media. The first sensor may be configured to output a first signal in an instance in which the infrared light emitted from the first emitter is received by the first detector, the first signal indicative of the presence of the media. Moreover, the second detector may be positioned to receive infrared light emitted from the second emitter when media is present in the media path, due to, for example, in some exemplary embodiments, the infrared light reflecting off of a white (i.e., reflective) surface of the media. The second sensor may be configured to output a second signal in an instance in which the infrared light emitted from the second emitter is received, the second signal indicative of the presence of the media.

In an instance in which at least one of the first sensor or the second sensor provides the first signal or the second signal, the presence of media in the media path may be determined. In other words, the first signal and the second signal are each indicative of the presence of media in the media path. Whereas, in an instance in which neither signal is provided, in some embodiments, it may be determined that no media is in the media path.

In some embodiments, gap detection may be performed such that, in an instance in which the second detector of the second sensor, which is positioned to receive infrared light transmitted by the first emitter of the first sensor when media is absent from the media path, receives the infrared light emitted by the first emitter. One of ordinary skill would appreciate that when the media is absent, the media liner may still be present. That is, the media liner of the media may be transmissive enough to pass the, for example, infrared light to the second detector, thus detecting the presence of a gap. However, when media (e.g., a label) is present between the first emitter and the second detector, the infrared light may be unable to pass through, and thus light is not detected by the second detector. Additionally or alternatively, black bar detection may be performed, such that when one of the first or second signal is provided, due to, for example, in some exemplary embodiments, the infrared light reflecting back off of a white surface of the media and being received by one of the first or second detector. The signal of the first and second signal that is not received may be due to, for example, in some exemplary embodiments, the infrared light failing to reflect back off of a black surface (e.g., a black bar used for media registration by the printer) of the media. A black bar may be located and determined on either surface of the media.

As will be apparent to one of ordinary skill in the art in view of the foregoing disclosure, the dual sensor media detection system described herein may allow a more accurate determination of media presence or absence. It may further allow for a more accurate identification of gaps between labels that are carried on relatively translucent media. Printers incorporating dual sensor media detection systems as described herein may be configured to leverage such accuracy by using smaller platen drive motors and otherwise optimizing operation efficiency while maintaining performance.

### System Architecture and Example Apparatus

The devices, systems, and methods of the present invention may be used by manufacturers, distributors, retailers, and others for printing needs, such as printing shipping labels or product label tags. The devices, systems, and methods described provide an ability to quickly and easily manage supplies and products, store information on product labels, and aid in product shipping. The devices, systems, and methods may be standalone applications, or they may communicate with other devices to help facilitate management of products or supplies.

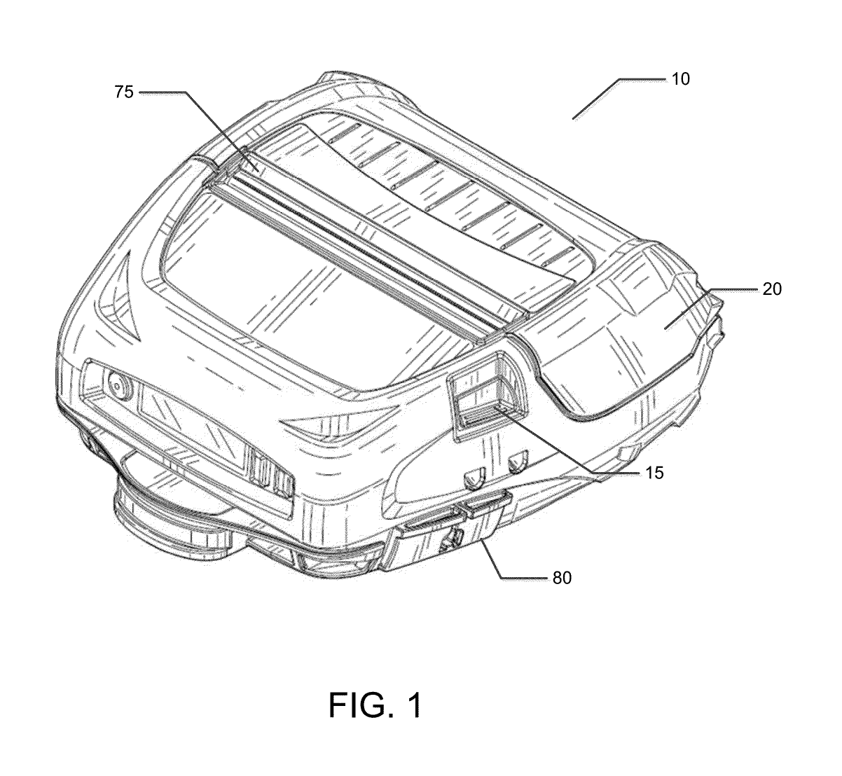

One such application is that of a printer 10, as seen in FIG. 1. For the purposes of explanation, the printer 10 will be described in terms of a portable direct thermal printer, although it is understood that the devices, systems, and methods of embodiments of the present invention may be used for any printer or device with similar components including thermal transfer printers. The printer 10 may be used for encoding and reading RFID tags as well as printing labels.

An embodiment of the printer 10 may be useful in a fast-paced moving environment due to its portability. The relatively small, lightweight design of the printer 10 allows the printer to be easily picked up and carried. As such, the printer 10 may comprise one or more attachment openings. The attachment openings may be configured to engage a latching mechanism for connection to and/or the support of a cradle or other device or support. To further allow for portability, the printer 10 may include one or more batteries, e.g., a smart battery, as a power source. In this way, the printer 10 may be quickly moved to convenient locations without regard for the location of power outlets. In some cases, the battery may be external to the printer, as in the case when a separate battery is provided on a cart, or when the battery in a vehicle is used to provide power for the printer.

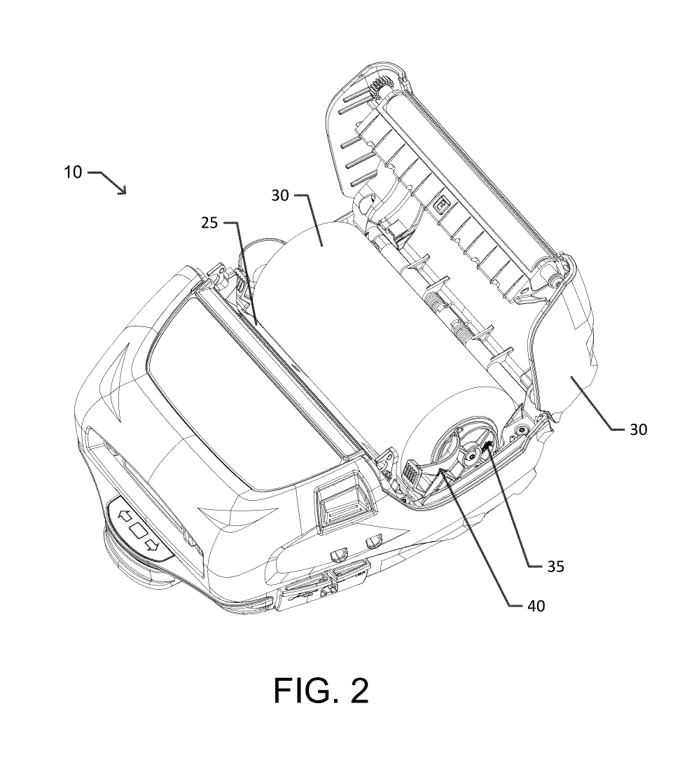

Referring again to FIG. 1, the printer 10 may include a media cover 20. In some embodiments, the media cover 20 may be opened using a media cover button 15. As seen in FIG. 2, the media cover 20 encloses a media receiving area 25, such as a cavity, which stores media 30, such as shipping labels. The media 30 can be inserted between opposing media support arms 35 that are configured to center and securely hold the media 30 in place.

In some embodiments, the printer 10 may include one or more input data ports for importing data from or exporting data to an external source. Data imported could include printing commands, status requests, e-mail, printer settings, executable computer code, definitions for formatting data, fonts, graphics, passwords, or maintenance data. The data could be provided from a data storage medium, such as a computer, web site, portable data terminal, mobile phone, bar code reader, RFID reader, weigh scale, truck radio, or even another printer. Communication could be via a Universal Serial Bus (USB), Ethernet stack, wireless radio, or the like. These data ports can be located under the data port cover 80 and may be configured to facilitate data transmission to the printer 10 during operation to help facilitate tasks like storing information or printing certain labels. Data could also be exported from these ports to help with product information storing and shipment tracking. Data exported could include the response to status requests, e-mail, network messages, printer status or settings, stored customer data, passwords, maintenance data, printer alert conditions, information read from RFID tags on the ribbon or supplies, battery status, external battery conditions, or information derived from sensors within the printer such as power conditions, supply measurements, temperature, or printhead conditions.

Various embodiments of the printer 10 may also utilize wired and/or wireless communications techniques and/or protocols for communications with, and control of, the printer 10 via the data ports described above. These communications techniques and/or protocols may allow for tethered and/or untethered operation of the printer 10. In this regard, the printer may include a communications interface that may be controlled by various means, including one or more processors. The one or more processors may be software and/or hardware configured and may control various communications hardware that may be used to implement communications with a remote device (e.g., a host device). The processor(s) may be configured to communicate using various wired and wireless communications techniques and/or protocols including serial and parallel communications and printing protocols, USB techniques, transmission control protocol/internet protocol (TCP/IP), radio frequency (RF), infrared (IrDA), or any of a number of different wireless networking techniques, including WLAN techniques such as, IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, Bluetooth (BT), ultra wideband (UWB) and/or the like. The printer 10 may implement these and other communications techniques and/or protocols directly with a host device in a point-to-point manner, or indirectly through an intermediate device such as an access point or other network entity. Various host devices that may be used to communicate with and/or control the operation of printer 10 may include computers, mobile computers, cameras, scales, global positioning system (GPS) devices, radios, mobile terminals, media players, or the like.

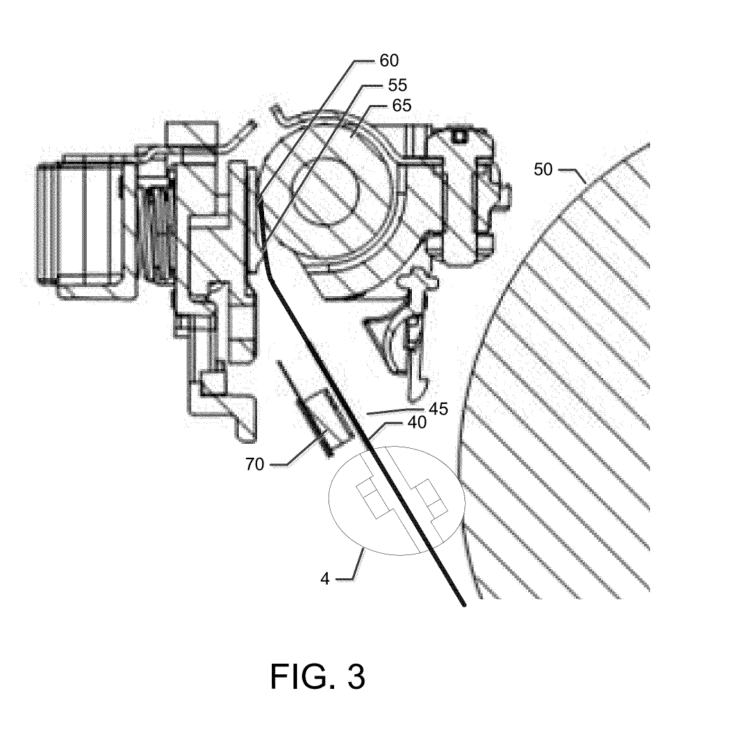

As seen in FIG. 3, when the printer 10 is closed and in typical operation, the media 30 is fed along a media path 45 extending from the media supply 50 to a nip 55 defined between a printhead 60 and a platen 65 (i.e., media drive roller). The media path 45 extends through a dual sensor array 4 that is positioned between the media supply 45 and the nip 55 defined between a printhead 60 and a platen 65. In some embodiments, prior to the media's passage through the dual sensor array 400, the media 40 passes over an RFID coupler 70 for encoding and reading of an RFID tag or inlay that may be applied to or embedded within the media 40.

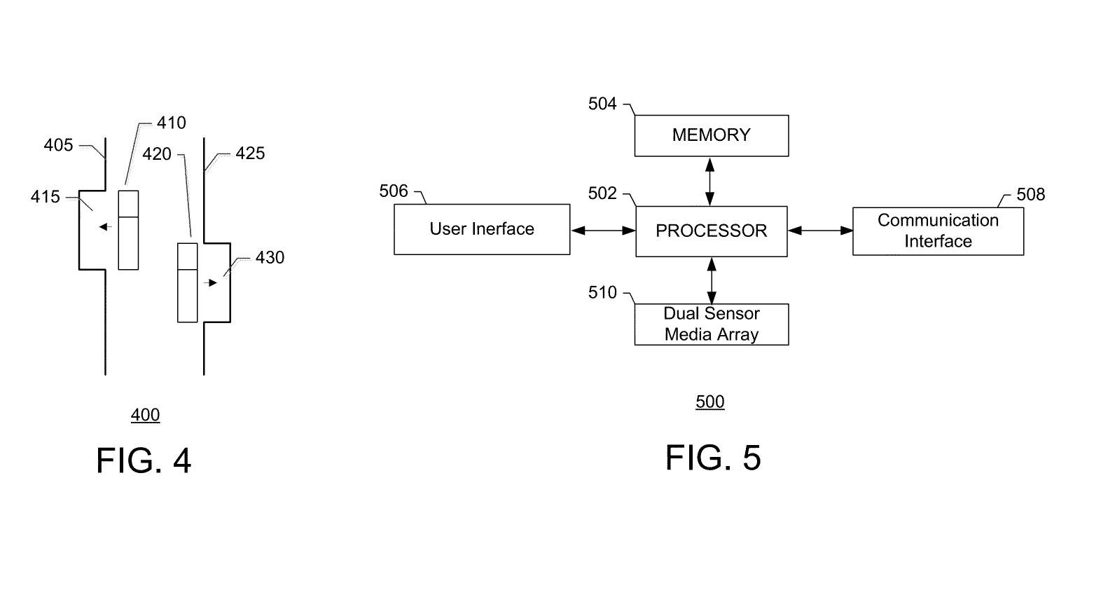

As shown in the detail view of FIG. 4, the depicted dual sensor array 400 comprises a first sensor 410 and a second sensor 420, the first sensor 410, as shown, disposed along a first media path guide 405 in a first recess 415. The second sensor 420 may be, as shown in FIG. 4, disposed along a second media path guide 425 in a second recess 430. Referring again to FIG. 1, once the label has been printed, the media exits the printer via the media exit slot 75. In embodiments, the printer 10 may include an optional peeler that functions to separate the printed media (e.g., the printed label) from a liner. In some embodiments, the peeled label may be discharged from the printer via the media exit slot 75, and the liner may be separately discharged, for example, via a liner exit slot. The printer 10 can include many different features that may combine to help meet various printing needs. Several of the features that may be included are described below with reference to the figures.

As shown in FIG. 4, the dual sensor array 400 may be configured such that media 40 may be fed from a supply spool 50 along the media path 45 toward the printhead 60 and platen 65, passing between two media sensors, a first media sensor 410 and a second media sensor 420. The depicted second media sensor 420 may be located in an upstream direction, or closer to the supply spool 50 and further from the printhead 60, relative to the first media sensor 410. In other embodiments, the first media sensor 410 may be located downstream of the second media sensor 420 (this view is not shown). In some embodiments, and as shown in FIG. 4, the first media sensor 410 may be located along a first media path guide 405 in a first recess 415. The second media sensor may be located along a second media path guide 425 in a second recess 430.

Each recess may be configured such that the spread of infrared light emitted from the emitter positioned therein is limited to a predetermined tolerance. In some embodiments, the sensors may be embedded or otherwise positioned such that the walls of the recess limit the spread to the predetermined tolerance. In some embodiments, the relative position (vertical and horizontal), type, and/or size of the two sensors may factor into the necessary depth of the recesses in meeting the predetermined tolerance. For example, where the two sensors are positioned further from each other measured from the center of the media path (e.g., vertically), the angle of the spread of a particular infrared light source may result in more spread. As such, a decreased depth may be employed to limit the spread. Moreover, when the two sensors are positioned closer to each other in the stream of the media path (e.g., horizontally), the decreased distance between, for example, the first emitter and second detector, necessitate an increased depth.

Furthermore, the depth of the recess may be a function of the particular type of Infrared light. For example, while a particular LED may have a limited spread, and as such, may require more depth. A second type of emitter having a wider spread may require less depth.

### Exemplary System

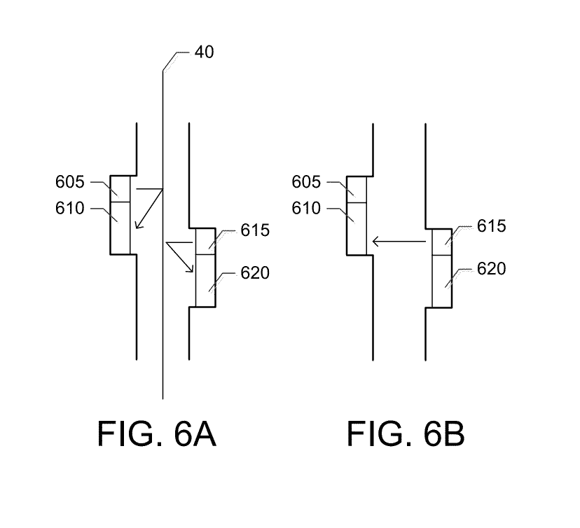

FIG. 5 shows a block diagram of an exemplary media detection system, such as for example, a dual sensor media detection system, that may be included in, for example, an apparatus, such as the printer 10 shown in FIG. 1. In some embodiments, however, the media detection system may be implemented in various other apparatuses that may require and/or benefit from the improved detection of media. FIG. 5 shows an exemplary dual sensor media detection system 500 including a processor 502, memory 504, user interface 506, and communication interface 508, each of which will be described later. Furthermore, as is shown in FIG. 5, dual sensor media detection system 500 may include a dual sensor media array 510, such as for example dual sensor array 400, described above with reference to FIG. 400, which is in communication with processor 502, memory 504, user interface 506, and communication interface 508.

### Exemplary Structure of Dual Sensor Array

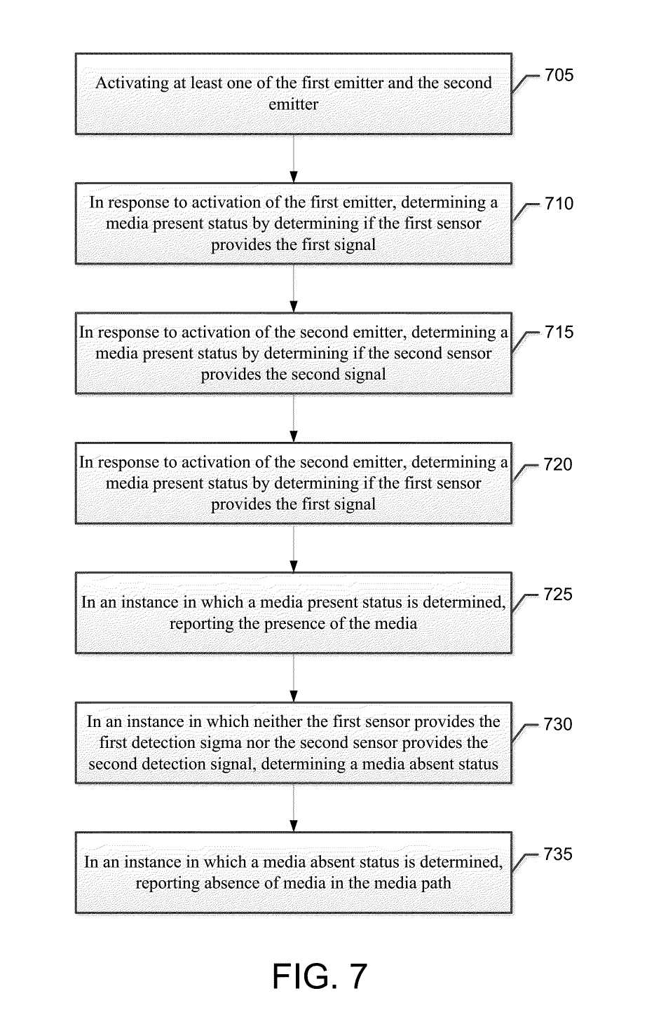

FIGS. 6A and 6B show further illustrations of exemplary block diagrams of the dual sensor array 400, which may be utilized or otherwise include in dual sensor media detection system 500, in accordance with various embodiments of the present invention. As shown in FIG. 6A, first media sensor 410 is located in first recess 415 and may comprise at least a first emitter 605 and a first detector 610. As shown, first sensor 410 may be disposed on the first media path guide 405 in a first recess 415. The first sensor 410 may be positioned in a first recess 415 such that the first detector 610 is positioned to receive infrared light emitted from the first emitter 605 when media 40 is present in the media path 45. In some embodiments, the first sensor 410 may be configured to output a first detection signal in an instance in which the infrared light emitted from the first emitter 605 is received, the first detection signal indicative of having received light emitted from first emitter 610, which, in some embodiments, may be utilized by a processor or the like, in the determination of presence of the media 40 in the media path 45.

As shown in FIG. 6A, second media sensor 620 is located in second recess 430 and may comprise at least a second emitter 615 and a second detector 620. As shown, second sensor 420 may be disposed on the second media path guide 425 in a second recess 430. The second sensor 420 may be positioned in a second recess 430 such that the second detector 620 is positioned to receive infrared light emitted from the second emitter 615 when media 40 is present in the media path 45. In some embodiments, the second sensor 420 may be configured to output a second detection signal in an instance in which the infrared light emitted from the second emitter 615 is received, the second detection signal indicative of having received light emitted from second emitter 615, which, in some embodiments, may be utilized by a processor or the like, in the determination of presence of the media 40 in the media path 45.

As shown in FIG. 6B, first detector 610 of the first sensor 410 may be positioned to receive infrared light transmitted by the second emitter 615 of the second sensor 420 when media 40 is absent from the media path 45. Furthermore, the second sensor 420 may be positioned offset from the first sensor 410. In some embodiments, the offset position of the second sensor 420 is configured to limit reception of infrared light transmitted by the first emitter 605 of the first sensor 410 when the media 40 is absent from the media path 45. That is, the offset distance may be such that the infrared light emitted from the first emitter 605 does not reach and thus, is not received by, the second detector 620. In some embodiments, the second detector 620 of the second sensor may be positioned to limit reception of infrared light transmitted by the first emitter 605 of the first sensor 410 when the media 40 is absent from the media path 45.

### Exemplary Process for Performing Media Detection Utilizing the Dual Sensor Media Detection System

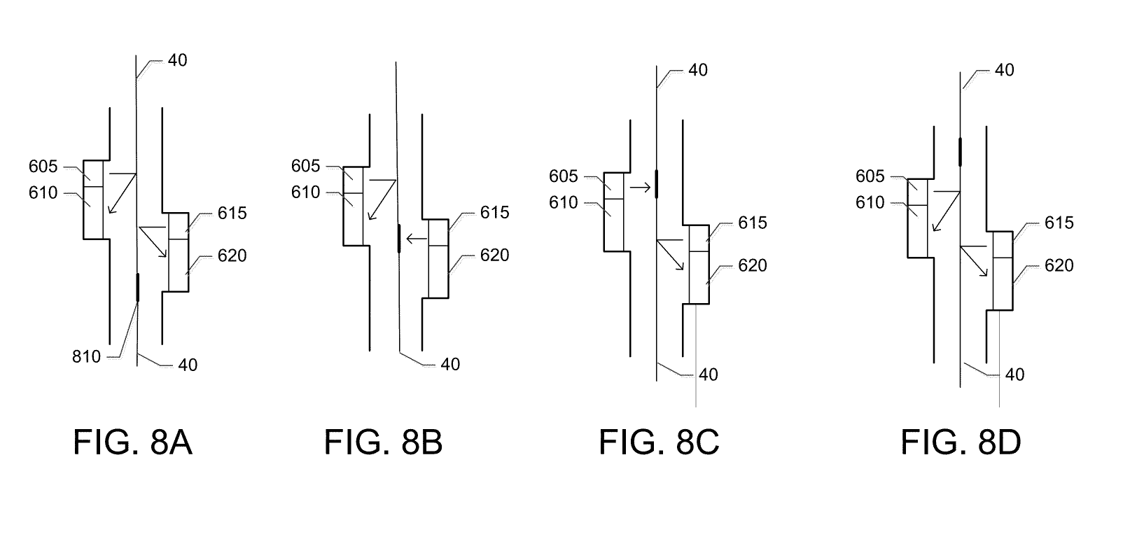

In some embodiments, in order to perform media detection, the dual sensor media detection system 500 may be configured such that infrared light is transmitted from the first emitter and second emitter in succession and a determination of whether media is present in the media path is made based on receiving signals indicative of the reception of the infrared light by the first detector and the second detector. As such, FIG. 7 shows an example process that may, in some embodiments, be executed or implemented by the system 500 or the processor 502. Various steps or operations of the exemplary method of FIG. 7 may be omitted, and various orderings of the steps or operations are contemplated. The exemplary process disclosed below allows various embodiments of the present invention to programmatically detect the presence of media in the media path.

As shown in block 705 of FIG. 7, an apparatus, such as dual sensor media detection system 500, or the control circuitry included therein, may be configured to activate at least one of the first emitter and the second emitter. In some embodiments, the first emitter may be activated first followed by the second emitter. In other embodiments, the second emitter may be activated first followed the first emitter. Activation, as used herein, is the causing of emission of infrared light. As described earlier, in some embodiments, the first and second emitters may be configured to transmit any form of electromagnetic energy, which may include but is not limited to infrared light. That is, in some embodiments, the first and second emitters may be configured to transmit and the first and second detectors may be configured to receive electromagnetic energy in the form of gamma rays, x rays, ultraviolet radiation, visible light, infrared radiation, microwaves and radio waves or energy of any other wavelength in the electromagnetic spectrum. In some embodiments, the first emitter and/or the second emitter may be a light-emitting diode (LED).

The detectors, being in a position to receive emitted infrared light may then be monitored. As such, as shown in block 710 of FIG. 7, an apparatus, such as dual sensor media detection system 500, or the control circuitry included therein, may be configured to, in response to activation of the first emitter, determine a media present status, by determining if the first sensor provides, has provided, or is providing the first signal. As shown in block 715 of FIG. 7, an apparatus, such as dual sensor media detection system 500, or the control circuitry included therein, may be configured to, in response to activation of the second emitter, determine a media present status, indicative of the present of the media in the media path, by determining if the second sensor provides, has provided, or is providing the second signal. In some embodiments, in response to the activation of the second emitter or in response to a subsequent activation of the second emitter, the first detector or first sensor may be monitored. In an instance in which the first sensor fails to provide the first signal, indicating, for example, the presence of media, the apparatus may determine a media present status. Accordingly, as shown in block 720 of FIG. 7, an apparatus, such as dual sensor media detection system 500, or the control circuitry included therein, may be configured to, in response to activation of the second emitter, determine a media present status, indicative of the present of the media in the media path, by determining if the first sensor provides, has provided, or is providing the first signal

In some embodiments, such as when the first signal has been provided in response to the activation of the first emitter, the second signal has been provided in response to activation of the second emitter, or the first signal has not been provided in response to the activation of the second emitter, the apparatus may determine a media present status and, in some embodiments, subsequently report the presence of the media. Accordingly, as shown in block 725 of FIG. 7, an apparatus, such as dual sensor media detection system 500, or the control circuitry included therein, may be configured to, in an instance in which a media present status has been determined, report the presence of the media.

In some embodiments, while the media present status may be determined and/or reported based on the reception of the first signal or the second signal, absence of both may not necessarily indicate the absence of media in the media path. For example, in some embodiments, when the infrared light emitted from the first emitter is not received by the first detector and as such, the first sensor does not transmit or otherwise provide the first detection signal, a gap or a bar may be present which may prevent the reflection of the infrared light emitted from the first emitter. Similarly, when the infrared light emitted from the second emitter is not received by the second detector and as such, the second sensor does not transmit or otherwise provide the second detection signal, a gap or a bar may be present which may prevent the reflection of the infrared light emitted from the first emitter. In some embodiment, in an instance in which both the first sensor does not transmit the first detection signal and the second sensor does not transmit the second detection signal, a bar and a gap, two bars or two gaps may be present preventing the first emitter and second emitter's infrared light from being detected by the first detector and second detector respectively.

However, in some embodiments, media may be configured such that, when media is present in the media path, the media comprises a spacing of bars and/or gaps enabling detection by the dual sensor detection system. That is, the media may be configured such that, for example, a bar may not be present to absorb the infrared light emitted by the first emitter while a gap is present preventing reflection of the infrared light emitted by the second emitter. Additionally, in some embodiments, the media may be configured such that a gap may not be present preventing reflection of the infrared light emitted by the first while a bar is present absorbing the infrared light of the second emitter. Additionally, in some embodiments, two bar or two gaps may also not be present absorbing the infrared light of both emitters or preventing reflection of the infrared light of both emitters, respectively. As such, as shown in block 730 of FIG. 7, in some embodiments, an apparatus, such as dual sensor media detection system 500, or the control circuitry included therein, may be configured to, in an instance in which neither the first sensor provides the first detection sigma; nor the second sensor provides the second detection signal, determine a media absent status. Subsequent to determining a media absent status, as shown in block 735 of FIG. 7, in some embodiments, an apparatus, such as dual sensor media detection system 500, or the control circuitry included therein, may be configured to report absence of media in the media path.

### Exemplary Process for Performing Bar Detection Utilizing the Dual Sensor Media Detection System

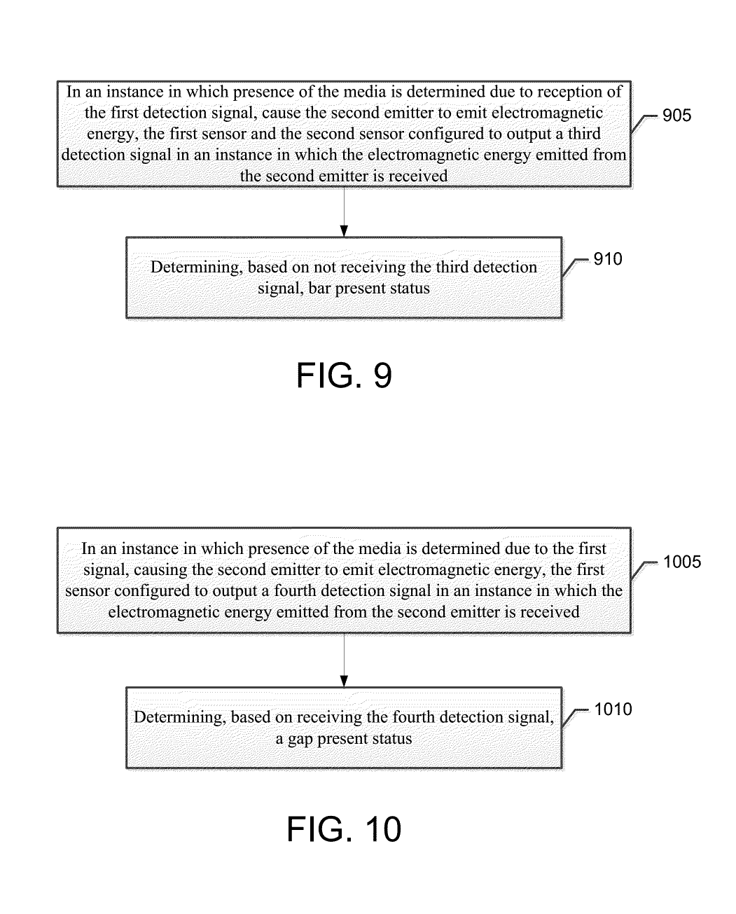

In some embodiments, the dual sensor media detection system 500 may be configured to perform bar detection and/or gap detection. In some embodiments, subsequent to the dual sensor media detection system 500 having determined the presence of media, the system may then detect bars or gaps based on, for example, the configuration of the printer. That is, in some embodiments, such as when the printer is set to print labels, the dual sensor media detection system may be configured to determine the presence of a gap, and when the printer is set to print, for example, receipts, the dual sensor media detection system 500 may be configured to determine the presence of a bar. Advantageously, the dual sensor media detection system 500 may be configured to detect a bar on either side of the media. FIGS. 8A-8D show the dual sensor media detection system 500 as media 40, having a bar 810, passes through the media path. For example, as shown in FIG. 8A, bar 810 is located upstream of both the first sensor 410 and the second sensor 420 and, consequently has not yet reached the dual sensor array 400. As such, both the first sensor 410 and the second sensor 420 will detect media in the media path but will not detect the presence of the bar 810.

A “bar” as referenced herein may be provided on either side of media 40 and cover some portion of the width of the media. In some embodiments, the bar is opaque or otherwise non-translucent, black, or in other embodiments, semi-opaque, thus limiting some portion of light through able to be detected. As shown in FIG. 8A-8D, a bar 810 on the media 40 as it passes through the media path 45, may obstruct or limit the reception of the infrared light transmitted from the first emitter 605 and/or second emitter 615.

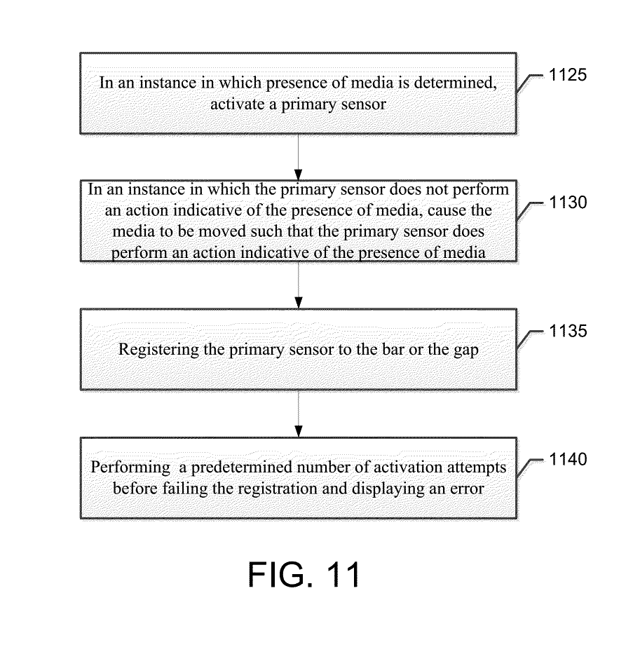

FIG. 9 shows an exemplary process that may, in some embodiments, be executed by an dual sensor media detection system 500, for performing bar detection. FIG. 9 is described in conjunction with Table 1, shown below, which illustrates a result of the dual sensor media detection system 500 performing bar detection at each of the four positions, which will be referred to as A, B, C, and D, each corresponding to the positions shown in FIGS. 8A-8D. For example, as described above with reference to FIG. 8A, bar 810 is located upstream of both the first sensor 410 and the second sensor 420 and, consequently both the first sensor 410 and the second sensor 410 may provide the first detection signal and second detection signal, respectively. Consequently, both the first sensor 410 and the second sensor 410 provide a signal configured to be utilized by the media detection system 500 to determine a media present status but not a bar present status. That is, media may be determined to be present in the media path and no bar may be determined to be present. As such, the dual sensor media detection system 500 may provide or report a media present status. In some embodiments, the dual sensor media detection system may provide a result indicative of no bar present status or a determination that no bar is present, or the like

As shown in FIG. 8B, bar 810 is located upstream of the first sensor 410 and positioned such that the infrared light transmitted by the second emitter of the second sensor 420 will be absorbed, at least in part, and, consequently the first sensor 410 will provide a first detection signal indicative, for example, of media 40 in the media path 45 but will not detect the presence of the bar 810 while the second sensor 420 will not provide the second detection signal indicative to, for example, the processor, of media in the media path. As such, the dual sensor media detection system 500 may provide a media present status indicative of, for example, a result indicative of media being present in the media path, and a first side bar present status or, in some embodiments, a bar present status, indicative of a bar being present on the first side of the media at position C or a bar being present at the correct position, that is position B, respectively. That is, in some embodiments, when the first sensor fails to provide the first detection signal, the apparatus or control circuitry may be configured to determine that a bar is present.

As shown in FIG. 8C, bar 810 is located downstream of the second sensor 420 and positioned such that the infrared light transmitted by the first emitter 605 of the first sensor 410 will be absorbed, at least in part. Consequently the second sensor 420 will provide the second detection signal, which may be utilized by the processor or the like in the determination of a media present status, but will not provide an indication that may be utilized in the detection of the presence of the bar 810 while the first sensor 410 will not provide the first detection signal, indicative to the processor or the like in not detecting media in the media path. As such, the dual sensor media detection system 500 may provide a media present status indicating a result indicative of media being present and a second side bar present status or, in some embodiments, a bar present status, indicative of a bar being present on the second side of the media at position C or bar being present at the correct position, that is position C, respectively. That is, in some embodiments, when the second sensor fails to provide the second detection signal, the apparatus or control circuitry may be configured to determine that a bar is present.

As shown in FIG. 8D, bar 810 is located downstream of both the first sensor 410 and the second sensor 420. Consequently both the first sensor 410 and the second sensor 410 will provide signal configured to be utilized by the media detection system 500 to determine a media present status but not a bar present status. That is media may be determined to be present in the media path and no bar may be determined to be present. As such, the dual sensor media detection system 500 may provide or report a media present status. In some embodiments, the dual sensor media detection system may provide a result indicative of no bar present status or a determination that no bar is present, or the like.

| Position | First sensor | Second Sensor | System Status |
|---|---|---|---|
| A | Provides first | Provides second | Media Present |
| | detection signal | detection signal | |
| B | Provides first | Provides no | Media Present |
| | detection signal | signal | Second Side Bar |
| | | | Present |
| C | Provides no | Provides second | Media Present |
| | signal | detection signal | First Side Bar |
| | | | Present |
| D | Provides first | Provides second | Media Present |
| | detection signal | detection signal | |

The exemplary process disclosed below allows various embodiments of the present invention to be configured to utilize the dual sensor media detection system 500 to perform bar detection. Accordingly, as shown in block 905 of FIG. 9, an apparatus, such as dual sensor media detection system 500, or the control circuitry included therein, may be configured to, in an instance in which presence of the media is determined due to reception of the first detection signal, cause the second emitter to emit infrared light, the first sensor and the second sensor configured to output a third detection signal in an instance in which the infrared light emitted from the second emitter is received.

As shown in block 910 of FIG. 9, an apparatus, such as dual sensor media detection system 500, or the control circuitry included therein, may be configured to determine, based on not receiving the first detection signal, a bar present status, which may be indicative of the presence of the bar on the first side of the media. That is, consistent with Table 1, when the first sensor detects media present in the media path and neither the first detector nor the second detector receive infrared light emitted from the second emitter, a media present status and a bar present status may be determined indicating that, for example, media is determined to be present in the media path and a bar is determined to be present at position B. In other words, when a bar is present at position B, no infrared light, or less than a predetermined threshold of infrared light, may be received by either the first detector 610 or the second detector 620.

In some embodiments, in an instance in which presence of the media is determined due to the second signal, the apparatus may be further configured to cause the first emitter to emit infrared light. The first sensor may not receive infrared light, which may be due to the presence of a bar. As such, in some embodiments, the apparatus may be configured such that one or more predetermined thresholds may be utilized. For example, a bar may reflect at least some portion of the infrared light, the portion may be less than the portion of infrared light that media itself may reflect. Moreover, the first detector may receive some portion of the infrared light emitted by the first emitter, less than the presence of a bar may allow, but more than the presence of a gap may allow. Accordingly, the second sensor may be configured to output a third detection signal in an instance in which a portion of the infrared light emitted from the first emitter received by the first detector meets a predetermined threshold.

### Exemplary Process for Performing Gap Detection Utilizing the Dual Sensor Media Detection System

FIG. 10 shows an example process that may, in some embodiments, be executed by an dual sensor media detection system 500. The exemplary process disclosed below allows various embodiments of the present invention to be configured to utilize the dual sensor array 400 to perform gap detection. In other words, the first sensor 410 and the second sensor 420 may be utilized by an apparatus to, for example, detect a gap in the media 40 in the media path 45. As shown in block 1005 of FIG. 10, an apparatus, such as dual sensor media detection system 500, or the control circuitry included therein, may be configured to, in an instance in which presence of the media is determined due to first signal, cause the second emitter 615 to emit infrared light. The first sensor 410 may be configured to output a fourth detection signal in an instance in which the infrared light emitted from the second emitter 615 is received. As shown in block 1010 of FIG. 10, an apparatus, such as dual sensor media detection system 500, or the control circuitry included therein, may be configured to determine, based on reception of the fourth detection signal, a gap present status which may be indicative of the presence of a gap. That is, when the dual sensor detection system 500 has detected a media present status and has detected that light emitted from the second emitter is being received by the first detector of the first sensor, a gap in the media is present in the path of the infrared light emitted from the second emitter, thus enabling the first detector to receive that infrared light. Conversely, in an instance in which the infrared light emitted from the second emitter 615 is not received by the first detector 610, a gap present status is not determined and a determination that no gap is present may be made. That is, when the dual sensor detection system 500 has detected the presence of media and has detected that light emitted from the second emitter is not being received by the first detector of the first sensor, a gap in the media is not present in the path of the infrared light emitted from the second emitter, thus disallowing the first detection to receive that infrared light.

As will be appreciated, computer program code and/or other instructions may be loaded onto a computer, processor or other programmable apparatus's circuitry to produce a machine, such that execution of the code on the machine by the computer, processor, or other circuitry creates the means for implementing various functions, including those described herein.

### Registration

FIG. 11 shows a flowchart describing an exemplary process in which a gap or a bar may be registered upon the determination of the presence of media and detection of the gap or bar. For example, once the apparatus has determined a media present status and a bar present status or gap present status is detected, the apparatus may activate either sensor, for example, the sensor that has detected presence of the bar or the gap, and engage the driving mechanism to move the media such that the apparatus may then register the sensor to the detected bar or gap. Accordingly, as shown in block 1125 of FIG. 11, an apparatus, such as dual sensor media detection system 500, or the control circuitry included therein, may be configured to, in an instance in which presence of media is determined, activate a primary sensor. In some embodiments, the primary sensor may be either one of the first sensor or the second sensor, or may be the combination of the first emitter and the second detector, which may be referred to as a gap sensor.

In an instance in which the apparatus has determined the presence of media, but upon activation of the primary sensor, media is not detected (e.g., media was detected based on the reception of the first signal in response to activation of the first emitter, but the primary sensor is the second sensor). As shown in block 1130 of FIG. 11, an apparatus, such as dual sensor media detection system 500, or the control circuitry included therein, may be configured to, in an instance in which the primary sensor does not perform an action indicative of the presence of media, engage the driving mechanism to move the media such that the primary sensor does perform an action indicative of the presence of media. That is, when the primary sensor is the first sensor, the action is to provide the first signal, when the primary sensor is the second sensor, the action is to provide the second detection signal, and when the primary sensor is the combination of the second emitter and first detector, the action is not providing the first detection signal. Upon the engagement of the driving mechanism, movement of the media, and subsequent action of the primary sensor indicative of the presence of media, a bar or a gap can be registered to the primary sensor. As shown in block 1135 of FIG. 11, an apparatus, such as dual sensor media detection system 500, or the control circuitry included therein, may be configured to register the primary sensor to the bar or the gap. In some embodiments, based on the position of a bar or a gap on the media, a single engagement of the driving mechanism and resulting movement of the media may not result in the primary sensor performing an action indicative of the presence of media, and as such, the causing of the movement of media and subsequent media detection may be performed one or more additional times. If after a predetermined number of time, the primary sensor still does perform an action indicative of the presence of media, an error may be occurring. In one exemplary embodiment, if a media present status is determined based on the reception of the second detection signal, and the primary sensor is the first sensor, which upon activation of the first emitter, is not providing the first detection signal, a bar may be present and the media may need to be fed just far enough to move the bar out of position of the first emitter. In another exemplary embodiment, if a media present status is determined based on the reception of the second detection signal, and the primary sensor is the first sensor, which upon activation of the first emitter, is not providing the first detection signal, media may need to be fed downstream (e.g., 50 lines or the like). As such, as shown in block 1140 of FIG. 11, an apparatus, such as dual sensor media detection system 500, or the control circuitry included therein, may be configured to perform a predetermined number of activation attempts. In some embodiments, subsequent to the predetermined number of activation attempts being performed, the apparatus may be further configured to fail the registration and/or display an error message.

As described above and as will be appreciated based on this disclosure, embodiments of the present invention may be configured as methods, mobile devices, backend network devices, and the like. Accordingly, embodiments may comprise various means including entirely of hardware or a combination of software and hardware. Furthermore, embodiments may take the form of a computer program product on at least one computer-readable storage medium having computer-readable program instructions (e.g., computer software) embodied in the storage medium. Any suitable computer-readable storage medium may be utilized, including non-transitory hard disks, CD-ROMs, flash memory, optical storage devices, magnetic storage devices, or the like.

Embodiments of the present invention have been described above with reference to block diagrams and flowchart illustrations of methods, apparatuses, systems and computer program products. It will be understood that each block of the circuit diagrams and process flowcharts, and combinations of blocks in the circuit diagrams and process flowcharts, respectively, can be implemented by various means including computer program instructions. These computer program instructions may be loaded onto a general purpose computer, special purpose computer, or other programmable data processing apparatus to produce a machine, such that the computer program product includes the instructions which execute on the computer or other programmable data processing apparatus create a means for implementing the functions specified in the flowchart block or blocks.

These computer program instructions may also be stored in a computer-readable storage device that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus, thereby producing a computer-implemented process such that the instructions executed on the computer or other programmable apparatus cause performance of the steps and thereby implement the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions.

### Example Apparatus for Implementing Embodiments of the Present Invention

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of dual sensor media detection system 500 may provide or supplement the functionality of particular circuitry. For example, the processor 502 may provide processing functionality, the memory 504 may provide storage functionality, the communications interface 508 may provide network interface functionality, and the like.

In some embodiments, the processor 502 (and/or co-processor or any other processing circuitry assisting or otherwise associated with the processor) may be in communication with the memory 504 via a bus for passing information among components of the apparatus. The memory 504 may be non-transitory and may include, for example, one or more volatile and/or non-volatile memories. In other words, for example, the memory may be an electronic storage device (e.g., a computer readable storage medium). The memory 504 may be configured to store information, data, content, applications, instructions, or the like, for enabling the apparatus to carry out various functions in accordance with example embodiments of the present invention.

The processor 502 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 502 may be configured to execute instructions stored in the memory 504 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the dual sensor media detection system 500 may include input/output circuitry 206 that may, in turn, be in communication with processor 502 to provide output to the user and, in some embodiments, to receive an indication of a user input. The input/output circuitry 506 may comprise a user interface and may include a display and may comprise a web user interface, a mobile application, a client device, a kiosk, or the like. In some embodiments, the input/output circuitry 506 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 504, and/or the like).

The communications circuitry 508 may be any means such as a device or circuitry embodied in either hardware or a combination of hardware and software that is configured to receive and/or transmit data from/to a network and/or any other device, circuitry, or module in communication with the apparatus 20. In this regard, the communications circuitry 508 may include, for example, a network interface for enabling communications with a wired or wireless communication network. For example, the communications circuitry 508 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

It is also noted that all or some of the information presented by the example displays discussed herein can be based on data that is received, generated and/or maintained by one or more components of dual sensor media detection system 500. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A media detection apparatus comprising:
a first sensor comprised of a first emitter and a first detector, the first sensor disposed on a first side of a media path;
a second sensor comprised of a second emitter and a second detector, the second sensor disposed on a second side of the media path,
wherein the first detector of the first sensor is positioned to receive electromagnetic energy transmitted by the second emitter of the second sensor when media is absent from the media path, and
wherein the second sensor is positioned offset from the first sensor

2. The media detection apparatus according to claim 1, further comprising:
a first media path guide defining a first recess; and
a second media path guide defining a second recess,
wherein the first sensor is positioned in the first recess such that the first detector is positioned to receive electromagnetic energy emitted from the first emitter when media is present in the media path, the first sensor configured to output a first detection signal in an instance in which electromagnetic energy is received, and
wherein the second sensor is positioned in the second recess such that the second detector is positioned to receive electromagnetic energy emitted from the second emitter when media is present in the media path, the second sensor configured to output a second detection signal in an instance in which electromagnetic energy emitted is received.

3. The media detection apparatus according to claim 2, further comprising:
control circuitry configured to:
activate at least one of the first emitter and the second emitter to transmit electromagnetic energy;
in response to activation of the first emitter, determine a media present status by determining if the first sensor provides the first detection signal;
in response to activation of the second emitter, determining a media present status by determining if the second sensor provides the second signal or if the first signal fails to provide the first signal; and
in an instance in which the media present status is determined, reporting the presence of the media.

4. The media detection apparatus according to claim 1, wherein the second sensor is positioned upstream of the first sensor.

5. The media detection apparatus according to claim 1, further comprising:
a driving mechanism for moving the media along the media path,
wherein the control circuitry is further configured to:
in an instance in which the media present status is determined, activate a primary sensor, the primary sensor being one of the first sensor, the second sensor, or the gap sensor;
engage the driving mechanism to move the media such that a bar or a gap can be registered to the primary sensor;
register the primary sensor to the bar or the gap.

6. The media detection apparatus according to claim 3, the control circuitry further configured to perform bar detection,
bar detection comprising:
in an instance in which presence of the media is determined due to the first detection signal, causing the second emitter to emit electromagnetic energy, the first sensor and the second sensor configured to output a third detection signal in an instance in which the electromagnetic energy emitted from the second emitter is received; and
determining, based on not receiving the third detection signal, presence of the bar on the first side of the media.

7. The media detection apparatus according to claim 3, the control circuitry further configured to perform bar detection,
bar detection comprising:
in an instance in which presence of the media is determined due to the first detection signal,
causing the second emitter to emit electromagnetic energy, the first sensor and the second sensor configured to output a third detection signal in an instance in which a portion of the electromagnetic energy emitted from the second emitter received at the first detector or the second detector meets a predetermined threshold; and
determining, based on not receiving the third detection signal, presence of the bar on the first side of the media.

8. The media detection apparatus according to claim 3, the control circuitry further configured to perform gap detection,
gap detection comprising:
in an instance in which presence of the media is determined due to first signal, causing the second emitter to emit electromagnetic energy, the first sensor configured to output a fourth detection signal in an instance in which the electromagnetic energy emitted from the second emitter is received; and
determining, based on reception of the fourth detection signal, a gap present status.

9. The media detection apparatus according to claim 1, wherein the electromagnetic energy is infrared light.

10. A method for determining whether a media object is present in a media detection apparatus, the method comprising:
activating a first emitter, the first emitter being a part of a first sensor, the first sensor further comprised of a first detector, the first sensor positioned such that the first emitter is positioned to emit electromagnetic energy toward a media path and the first detector is positioned to receive electromagnetic energy emitted from the first emitter and reflected off a first side of a media, the first sensor configured to provide a first detection signal in an instance in which electromagnetic energy is received by the first detector;
in response to activation of the first emitter, determining a media present status in an instance in which a first detection signal is received from the first sensor;
activating a second emitter, the second emitter being a part of a second sensor, the second sensor further comprised of a second detector, the second sensor positioned such that the second emitter is positioned to emit electromagnetic energy toward the media path and the second detector is positioned to receive the electromagnetic energy emitted from the second emitter and reflected off a second side of the media, the first detector of the first sensor positioned to receive electromagnetic energy transmitted by the second emitter of the second sensor when media is absent from the media path, the second sensor configured to provide a second detection signal in an instance in which electromagnetic energy is received by the second detector;
in response to activation of the second emitter, determining a media present status in an instance in which in which a second detection signal is received from the second sensor or in an instance in which the first detection signal is not received from the first sensor; and
in an instance in which the media present status is determined, reporting the presence of the media.

11. The method according to claim 10, wherein the second sensor is positioned upstream of the first sensor.

12. The method according to claim 10, further comprising:
in an instance in which the media present status is determined, activating a primary sensor, the primary sensor being one of the first sensor, second sensor, or a gap sensor;
engaging a driving mechanism to move the media such that a bar or a gap can be registered to the primary sensor, the driving mechanism configured for move the media along a media path; and
registering the primary sensor to the bar or the gap.

13. The method according to claim 12, further comprising:
performing a predetermined number of activation attempts before failing the registration and displaying an error.

14. The method according to claim 10 further configured for bar detection, the method further comprising:
in an instance in which presence of the media is determined due to the first detection signal, causing the second emitter to emit electromagnetic energy, the first sensor and the second sensor configured to output a third detection signal in an instance in which the electromagnetic energy emitted from the second emitter is received; and
determining, based on not receiving the third detection signal, a bar present status.

15. The method according to claim 10 further configured for bar detection, the method further comprising:
in an instance in which presence of the media is determined due to the first detection signal,
causing the second emitter to emit electromagnetic energy, the first sensor and the second sensor configured to output a third detection signal in an instance in which a portion of the electromagnetic energy emitted from the second emitter received at the first detector or the second detector meets a predetermined threshold; and
determining, based on not receiving the third detection signal, bar present status.

16. The method according to claim 10 further configured for gap detection, the method further comprising:
in an instance in which presence of the media is determined due to first detection signal, causing the second emitter to emit electromagnetic energy, the first sensor configured to output a fourth detection signal in an instance in which the electromagnetic energy emitted from the second emitter is received, the fourth detection signal indicative of the presence of a gap; and
determining, based on reception of the fourth detection signal, a gap present status.

17. The method according to claim 10, wherein the electromagnetic energy is infrared light.

18. A printer comprising:
a dual sensor media detection system and control circuitry,
the dual sensor media detection system comprising:
a first sensor comprised of a first emitter and a first detector, the first sensor disposed on a first side of a media path;
a second sensor comprised of a second emitter and a second detector, the second sensor disposed on a second side of the media path,
wherein the first detector of the first sensor is positioned to receive electromagnetic energy transmitted by the second emitter of the second sensor when media is absent from the media path, and
wherein the second sensor is positioned offset from the first sensor, and
the control circuitry configured to:
activate at least one of the first emitter and the second emitter to transmit electromagnetic energy;
in response to activation of the first emitter, determine a media present status by determining if the first sensor provides the first signal;
in response to activation of the second emitter, determine a media present status by determining if the second sensor provides the second signal or if the first signal fails to provide the first signal; and
in an instance in which the media present status is determined, reporting the presence of the media.

19. The printer according to claim 18, further comprising:
a first media path guide defining a first recess; and
a second media path guide defining a second recess,
wherein the dual sensor media detection system is further configured such that the first sensor is positioned in the first recess such that the first detector is positioned to receive electromagnetic energy emitted from the first emitter when media is present in the media path, the first sensor configured to output a first signal in an instance in which electromagnetic energy is received; and
the second sensor is positioned in the second recess such that the second detector is positioned to receive electromagnetic energy emitted from the second emitter when media is present in the media path, the second sensor configured to output a second signal in an instance in which the electromagnetic energy emitted from the second emitter is received.

20. The printer according to claim 18, further comprising:
a driving mechanism for moving the media along the media path,
wherein the control circuitry is further configured to:
in an instance in which the present status is determined, activate a primary sensor, the primary sensor being one of the first sensor, the second sensor, or a gap sensor;
engage the driving mechanism to move the media such that a bar or a gap can be registered to the primary sensor;
register the primary sensor to the bar or the gap.

21. The printer according to claim 18, wherein the control circuitry further configured to perform bar detection,
bar detection comprising:
in an instance in which presence of the media is determined due to the first detection signal, causing the second emitter to emit electromagnetic energy, the first sensor and the second sensor configured to output a third detection signal in an instance in which the electromagnetic energy emitted from the first emitter is received; and
determining, based on not receiving the third detection signal, presence of the bar on the first side of the media.

22. The printer according to claim 18, wherein control circuitry further configured to perform gap detection,
gap detection comprising:
in an instance in which presence of the media is determined due to first detection signal, causing the second emitter to emit electromagnetic energy, the first sensor configured to output a fourth detection signal in an instance in which the electromagnetic energy emitted from the second emitter is received, the fourth detection signal indicative of the presence of a gap; and
determining, based on reception of the fourth detection signal, presence of the gap.

23. The printer according to claim 18, wherein the electromagnetic energy is infrared light.
